(19) United States
(12) Patent Application Publication
(10) Pub. No.: US 2012/0085711 A1
(43) Pub. Date: Apr. 12, 2012

(54) PROCESS FOR THE OXIDATION OF WASTE ALKALI UNDER SUPERATMOSPHERIC PRESSURE

(75) Inventors: Hans-Jorg Zander, Munchen (DE); Holger Schmigalle, Wolfratshausen (DE); Timo Rathsack, Poing (DE)

(73) Assignee: LINDE AKTIENGESELLSCHAFT, Munchen (DE)

(21) Appl. No.: 13/268,368

(22) Filed: Oct. 7, 2011

(30) Foreign Application Priority Data
Oct. 7, 2010 (DE) 102010047726.5
Oct. 23, 2010 (DE) 102010049445.3

(51) Int. Cl. C02F 11/08; C02F 1/74

(52) U.S. Cl. 210/761; 210/177

(57) ABSTRACT

The invention relates to a process for the treatment of a used waste alkali, in which the used waste alkali is oxidized at a superatmospheric pressure in the range from 60 bar to 200 bar. The pressure of the used waste alkali L is increased and then heated by indirect heat exchange. The heated used waste alkali is conveyed into a separator, wherein vaporized aqueous phase is separated from the used waste alkali. The resultant liquid phase is brought to the desired reaction pressure and introduced into an oxidation reactor. In the oxidation reactor, the used waste alkali is oxidized. In a first reaction, thiosulphates are formed from the sulphides. In a second reaction, the thiosulphates are converted into more stable sulphates.

### SUMMARY OF THE INVENTION

The invention relates to a process for the treatment of a used waste alkali from a plant for preparing hydrocarbons by cracking of a hydrocarbon-containing feed, where the process has at least one step in which the used waste alkali is subjected to an oxidation by means of oxygen at elevated temperature under superatmospheric pressure.

Olefins such as ethylene or propylene are prepared by cracking of a hydrocarbon-containing feed. The relatively long-chain hydrocarbons of the starting material are, for example, converted into shorter-chain hydrocarbons such as ethylene and propylene by thermal cracking (steam cracking). The cracking gas formed by cracking is cooled, compressed and freed of undesirable constituents such as carbon dioxide, hydrogen sulphide and mercaptans in subsequent alkali scrub before being separated out into the individual hydrocarbons such as ethylene and propylene.

The used waste alkali formed in the alkali scrub has to be freed of toxic constituents before being introduced into a biological wastewater treatment. Likewise, the chemical oxygen demand of the used waste alkali has to be reduced. This is achieved according to the prior art by reduction of the typical sulphide content in the used waste alkali by wet chemical oxidation of the sulphide with oxygen in the solution.

In the prior art, various processes for the wet oxidation of used waste alkalis are known (e.g., C. B. Maugans, C. Alice “wet air oxidation: a review of commercial sub-critical hydrothermal treatment” IT3⁰² conference, 13-17/05/2002, New Orleans, La. or U.S. Pat. No. 5,082,571). These are based on the following general processes.

The used waste alkali is brought to the desired reaction pressure and heated in countercurrent with the oxidized waste alkali. The heated used waste alkali is subsequently fed into an oxidation reactor with introduction of oxygen and oxidized. Oxygen required for the reaction is added either as air or as pure oxygen. Additional heating of the used waste alkali can be achieved by introducing hot steam into the oxidation reactor. After a typical residence time of about 1 hour (depending on the temperature and pressure selected), the oxidized waste alkali together and the associated offgas are cooled, via a heat exchanger, by the used waste alkali that is to be heated. After adjusting the pressure, the offgas is separated from the liquid in a subsequent separation vessel. The liquid oxidized waste alkali can then be fed, after optional adjustment of the pH (neutralization), to a process for biological wastewater treatment.

An alternative process is described in DE10 2006 030855. In the process described in DE10 2006 030855, the oxidized waste alkali from the oxidation reactor is cooled by direct cooling using cold oxidized waste alkali from the separation vessel. The reaction temperature in the oxidation reactor is set without preheating of the used waste alkali by introduction of hot steam or hot air.

Therefore, an object of the present invention is to provide an alternative process for the treatment of a used waste alkali from a plant for preparing hydrocarbons by cracking of a hydrocarbon-containing feed. In the process according to the invention, the residence time in the oxidation reactor should if possible be shortened, the wastewater values of the oxidized waste alkali should be improved and/or the economics of the process should be improved.

Upon further study of the specification and appended claims, other objects and advantages of the invention will become apparent.

These objects are achieved by a process for the treatment of a used waste alkali (L) from a plant for preparing hydrocarbons by cracking of a hydrocarbon-containing feed, wherein the process comprises at least one step in which used waste alkali (L) is subjected to an oxidation by means of oxygen at elevated temperature under superatmospheric pressure, and the oxidation is carried out in a reactor (5) under a pressure in the range from 60 bar to 200 bar. Advantageous further embodiments are described herein.

According to the invention, the process for the oxidation is carried out in a reactor under a pressure in the range from 60 bar to 200 bar, for example, 60-100 bar or 110-170 bar, especially about 160 bar. Additionally, the oxidation is preferably performed at a temperature of 200-350° C.

As a result of the relatively high pressure in the oxidation reactor, especially in the pressure range indicated, the oxidation reaction of the sulphur compounds in the used waste alkali is significantly improved. The oxidation of the sulphur-containing compounds in the used waste alkali normally occurs in two different steps. In a first step, thiosulphates are formed from the sulphides of the used waste alkali. In a second step, these thiosulphates are converted into more stable sulphates. The first reaction of forming the thiosulphates from the sulphides proceeds significantly faster than the subsequent conversion of thiosulphates into sulphates in the second reaction. These two main reactions (reaction 1 and reaction 2) are in detail:

2Na₂S+2O₂°H₂O<==>Na₂S₂O₃+2NaOH (1)

Na₂S₂O₃+2NaOH<==>2Na₂SO₄+H₂O (2)

When the oxidation reaction is performed at a pressure range of, for example, from 6 to 10 bar, and a residence time in the oxidation reactor of from 6 to 8 hours at from 110° C. to 140° C., as in the prior art, a residue of from 20 to 30% of thiosulphates usually remains in the oxidized waste alkali. This residual thiosulphate can generally be processed without problems by biological wastewater treatment processes. Carrying out the process under superatmospheric pressure in the specified range according to the invention significantly accelerates reaction 2 and reduces the proportion of thiosulphate in the oxidized waste alkali to a few ppm. The wastewater quality and thus the chemical oxygen demand of the oxidized waste alkali are thus significantly improved. The subsequent biological wastewater treatment is simplified and a wastewater of higher quality is obtained. In addition, additional hydrocarbon impurities in the used waste alkali are oxidized when the oxidation reaction is carried out in the super-atmospheric pressure range according to the present invention. This further reduces the chemical oxygen demand of the oxidized waste alkali.

The residence time of the used waste alkali in the oxidation reactor can therefore also be significantly shortened while maintaining a comparable quality of the oxidized waste alkali by carrying out the oxidation reaction at the superatmospheric pressure in the specified range according to the invention as a result of the accelerated reaction 2. This improves the economics of the process of the invention. The oxidation reactor can be made smaller than in the prior art. Preferably, the residence time of the used waste alkali in the oxidation reactor is less than 2 hours, especially less than 1 hour.

The abovementioned pressure range according to the invention represents a compromise for carrying out the process economically. Carrying out the oxidation reaction at superatmospheric pressure according to the invention increases the static demands on the oxidation reactor. The oxidation reactor is thereby made more expensive than an oxidation reactor according to the prior art. These higher capital costs for the oxidation reactor are compensated by the improved economics due to the shorter residence time. The combination is optimal in the abovementioned pressure range according to the invention.

The process for the oxidation is preferably carried out at a pressure of 160 bar and a temperature of 280°. In this embodiment of the invention, the economics of the process is ideal as a result of the combination of the capital costs for the oxidation reactor, the shorter residence time of the used waste alkali in the oxidation reactor, and the improved wastewater quality of the oxidized waste alkali.

The pressure of the used waste alkali is advantageously increased to the pressure of the oxidation reaction in two separate pressure stages, with the used waste alkali being heated by indirect heat exchange with the oxidized waste alkali between the two pressure stages.

In this embodiment of the invention, both the capital costs and the energy balance of the process are improved. The oxidized waste alkali from the oxidation reactor has to be cooled, while the used waste alkali has to be heated to the reaction temperature before entry into the oxidation reactor. In this embodiment of the invention, the thermal energy of the oxidized waste alkali is therefore utilized for heating the used waste alkali by indirect heat exchange. Furthermore, the capital costs are advantageously minimized. The used waste alkali is aggressive. The heat exchanger for heating the used waste alkali therefore has to be made of high-grade material to protect it against the oxidized waste alkali. In this embodiment of the invention, the heat exchanger is positioned between the two pressure stages and therefore has to be designed only for the pressure of the first pressure stage and not for the significantly higher pressure of the second pressure stage. The heat exchanger can therefore be made with significantly lower wall thicknesses, so that material is saved and the capital costs of the plant are reduced. Only after heating to the reaction temperature is the pressure of the used waste alkali brought by means of the second pressure stage to the pressure of the oxidation reaction.

The used waste alkali after the first pressure stage and heat exchange with the oxidized waste alkali is advantageously fed to a separator where the gas phase is separated off from the used waste alkali. Positioning a separator downstream of the heat exchanger enables the amount of used waste alkali in the oxidation reactor to be minimized further. The heating in the heat exchanger significantly increases the proportion of gas in the used waste alkali. This gas can be separated off from the liquid phase of the used waste alkali in the separator in this embodiment of the invention. The gas consists essentially of water vapor and can be released into the environment directly without further process steps, for example via an acidic gas flare, or be utilized as process steam or heat transfer medium in another part of the plant. The waste alkali is thus concentrated as a result of the separation step between the two pressure stages. The volume of the waste alkali is reduced and the amount of wastewater and the reactor volume required are thus also reduced. The volume stream of the used waste alkali upstream of the oxidation reactor is smaller. In addition, the separator ensures that a gas-free liquid phase is fed to the second pressure stage.

The reactor for the oxidation of the used waste alkali is advantageously heated externally by indirect heat exchange. Indirect heating of the oxidation reactor can be combined with any embodiment of the invention described. Steam and oil are advantageously used here as the heating media.

During the heating of the oxidation reactor by introduction of hot steam, the temperature and especially the pressure conditions of the oxidation reaction are limited. In an ethylene plant, steam usually has a pressure of about 100 bar since this is the limit of the steam generation system in most plants. In heating of the oxidation reactor by direct introduction of hot steam, the pressure is therefore limited to 100 bar since the hot steam cannot be injected into a used waste alkali or an oxidation reactor at a higher pressure. The indirect external heating of the reactor thus makes it possible to realize significantly higher pressures.

In addition, steam losses inevitably occur in the overall steam system of the plant when the oxidation reactor is heated by means of steam injection. The injected steam remains as water or as vapor phase in the oxidized waste alkali downstream of the oxidation reactor. In the subsequent phase separation of the oxidized waste alkali containing the gas phase, steam is passed to combustion (alkali flare), while the liquid component of the oxidized alkali is passed to the system for biological wastewater treatment. In this way, steam is continually taken from the system/the plant. This is avoided by indirect heating of the oxidation reactor. In addition, the amount of wastewater is not increased but instead minimized by avoidance of direct injection of steam into the oxidation reactor.

It has likewise been found to be advantageous to additionally introduce oxygen into the used waste alkali upstream of the actual reactor. As a result of the additional introduction of oxygen upstream of the actual oxidation reactor, at least part of the sulphides is oxidized beforehand. Reaction 1 to form the thiosulphate proceeds even at a low pressure and low temperature. The reaction product of reaction 1 formed upstream of the oxidation reactor can thus directly react further in accordance with reaction 2 in the oxidation reactor. Since part of the reaction takes place before the actual oxidation reactor in this embodiment of the invention, a smaller amount of air has to be injected under high pressure into the oxidation reactor or into the used alkali in this embodiment of the invention, as a result of which the operating costs are minimized further compared to the prior art.

Preference is given to oxygen being additionally introduced into the used waste alkali directly after the first pressure stage. In this embodiment of the invention, the oxygen is in contact with the used waste alkali for a long time and is additionally heated together with the used waste alkali in the subsequent heat exchange stage. In this embodiment of the invention, excess oxygen can likewise be discharged into the atmosphere via the separator downstream of the heat exchange stage.

The introduction of oxygen via a bubble column upstream of the oxidation reactor is likewise advantageous. The bubble column can advantageously be positioned upstream of the first pressure stage or upstream of the second pressure stage. When a bubble column is used in this embodiment of the invention, the used waste alkali is fed into the bubble column. Oxygen is introduced from the bottom into the bubble column and thus bubbles through the used waste alkali in the bubble column. The bubble column is not completely filled with used waste alkali, so that the space above the surface of the liquid acts as separation space for the gas phase which is taken off via the top of the bubble column. The bubble column can advantageously be positioned upstream or downstream of the first pressure stage. When it is positioned downstream of the first pressure stage and downstream of the heat exchanger, the bubble column can, in specific embodiments of the invention, replace the separator upstream of the second pressure stage.

Furthermore, it has been found to be advantageous to introduce the oxygen into the oxidation reactor in countercurrent to the used waste alkali. The reaction of the sulphides to form the thiosulphates proceeds significantly more quickly than the reaction of the thiosulphates to form sulphates. In this embodiment of the invention, the highest oxygen concentration is thus achieved at the end of the oxidation reactor. In this way, it is ensured that all thiosulphates remaining in the oxidized waste alkali can be reacted to form sulphates.

The present invention is particularly suitable for the treatment of a used waste alkali as is obtained in the acidic gas scrub of an ethylene plant and contains mainly sulphur-containing impurities.

The process of the invention has a series of advantages over the prior art. As a result of the high pressure in the range according to the invention, all sulphur components in the used waste alkali are completely oxidized to sulphate. In addition, significant proportions of the dissolved hydrocarbons in the used waste alkali are also oxidized. As a result, the wastewater quality of the oxidized waste alkali is improved significantly compared to the prior art. As a result of the superatmospheric pressure according to the invention, the chemical reactions proceed significantly more quickly in the reactor. This leads to significantly shorter residence times and smaller reactor volumes. The economics of the overall process are thus improved.

### BRIEF DESCRIPTION OF THE DRAWINGS

The invention is illustrated schematically with reference to an exemplary embodiment in the drawing and will be described extensively hereinafter with reference to the drawing. Various other features and attendant advantages of the present invention will be more fully appreciated as the same becomes better understood when considered in conjunction with the accompanying drawing wherein:

FIG. 1 illustrates an embodiment according to the invention.

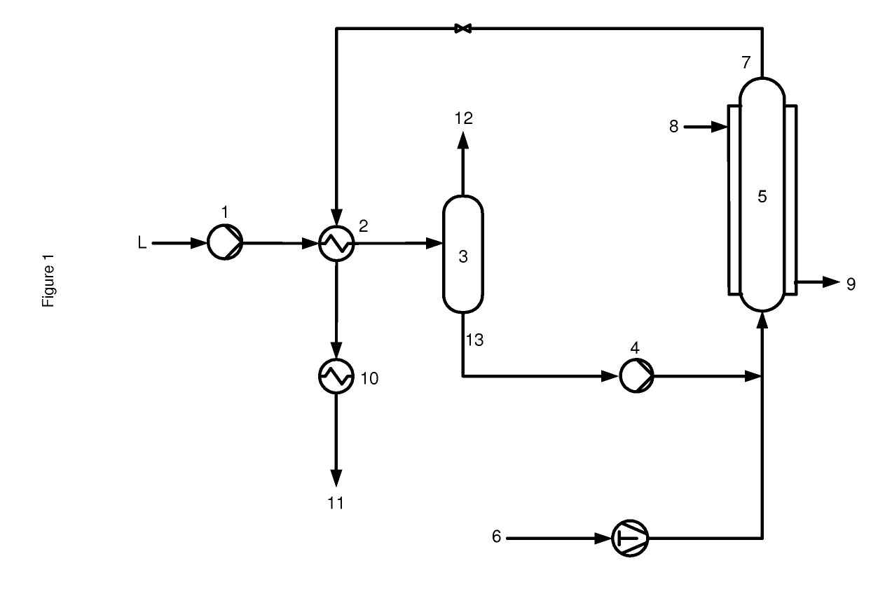

In the embodiment of the invention shown in the FIGURE, the pressure of the used waste alkali L is increased in a first pressure stage 1. In the subsequent heat exchanger 2, the used waste alkali is heated by indirect heat exchange with the oxidized waste alkali 7. The oxidized waste alkali 7 is cooled in this way. The heat exchanger 2 is configured as a countercurrent heat exchanger. The heated used waste alkali is conveyed from the heat exchanger 2 into a separator 3. In the separator 3, the vaporized aqueous phase is taken off from the used waste alkali and, as gas phase 12, either discharged into the atmosphere or used as process steam or heat transfer medium in the plant. The liquid phase 13 of the used waste alkali is brought to the desired reaction pressure in a second pressure stage 4 and fed together with compressed air 6 into the oxidation reactor 5. In the oxidation reactor 5, the used waste alkali is oxidized. Both reaction 1 and reaction 2 proceed in the oxidation reactor. The oxidized waste alkali 7 therefore contains neither sulphides or thiosulphates. The oxidation reactor 5 is heated externally by indirect heat exchange with high-pressure steam 8. The condensed high-pressure steam 8 is taken off as condensate 9 at the bottom of the reactor and recirculated to the condensate system. The oxidized waste alkali 7 is cooled in two stages, firstly in countercurrent in the heat exchanger 2 with heat exchange with the used waste alkali L and secondly in the heat exchanger 10 in countercurrent with cooling water. The oxidized waste alkali 7 after cooling can be conveyed via an optional neutralization (not shown) with removal of the gas phase (not shown) directly into a process for biological wastewater treatment 11.

The entire disclosure[s] of all applications, patents and publications, cited herein and of corresponding German Application No. DE 10 201 0 047726.5, filed Oct. 7, 2010 and German Application No. DE 10 201 0 049445.3, filed Oct. 23, 2010 are incorporated by reference herein.

The preceding examples can be repeated with similar success by substituting the generically or specifically described reactants and/or operating conditions of this invention for those used in the preceding examples.

1. A process for the treatment of a used waste alkali (L) from a plant for preparing hydrocarbons by cracking of a hydrocarbon-containing feed, said process comprising:
subjecting used waste alkali (L) to an oxidation by means of oxygen at elevated temperature under superatmospheric pressure,
wherein said oxidation is carried out in a reactor (5) under a pressure in the range of 60 bar-200 bar.

2. The process according to claim 1, wherein said oxidation is carried out at a pressure of 160 bar and a temperature of 280° C.

3. The process according to claim 1, wherein the pressure of the used waste alkali is increased to the pressure of the oxidation reaction in two separate pressure stages (1, 4), with the used waste alkali (L) being heated by indirect heat exchange (2) with the oxidized waste alkali (7) between the two pressure stages (1, 4).

4. The process according to claim 2, wherein the pressure of the used waste alkali is increased to the pressure of the oxidation reaction in two separate pressure stages (1, 4), with the used waste alkali (L) being heated by indirect heat exchange (2) with the oxidized waste alkali (7) between the two pressure stages (1, 4).

5. The process according to claim 3, wherein the used waste alkali (L), after the first pressure stage (1) and heat exchange (2) with the oxidized waste alkali (7), is fed to a separator (3) where a gas phase (12) is separated off from the used waste alkali (13).

6. The process according to claim 4, wherein the used waste alkali (L), after the first pressure stage (1) and heat exchange (2) with the oxidized waste alkali (7), is fed to a separator (3) where a gas phase (12) is separated off from the used waste alkali (13).

7. The process according to claim 1, wherein oxygen (6) is additionally introduced into the used waste alkali upstream of the actual reactor.

8. The process according to claim 3, wherein oxygen is additionally introduced into the used waste alkali directly after the first pressure stage.

9. The process according claim 8, wherein the oxygen is introduced into the used waste alkali via a bubble column

10. The process according to claim 1, wherein oxygen is introduced into the oxidation reactor (5) in countercurrent to the used waste alkali.

11. The process according to claim 1, wherein the used waste alkali (L) is obtained in the acidic gas scrub of an ethylene plant and contains mainly sulphur-containing impurities.

12. The process according to claim 1, wherein the oxidation reactor is heated externally by indirect heat exchange.

13. The process according claim 9, wherein the bubble column is positioned upstream of the first pressure stage.

14. The process according claim 9, wherein the bubble column is positioned upstream of the second pressure stage.

15. The process according claim 9, wherein the bubble column is positioned downstream of the first pressure stage.

16. The process according claim 9, wherein the bubble column is positioned downstream of the first pressure stage and downstream of the heat exchanger.

17. An apparatus for the treatment of a used waste alkali (L) from a plant for preparing hydrocarbons by cracking of a hydrocarbon-containing feed, said apparatus comprising:
a first pressure stage for increasing the pressure of a used waste alkali stream,
an indirect heat exchanger in fluid communication with said first pressure stage wherein a pressurized used waste alkali stream is heated by indirect heat exchange with an oxidized waste alkali stream,
a separator in fluid communication with said indirect heat exchanger wherein a vaporized aqueous phase can be separated from used waste alkali,
a second pressure stage in fluid communication with said separator wherein a liquid phase of used waste alkali is pressurized to 60 bar-200 bar,
an oxidation reactor having a inlet in fluid communication with said a second pressure stage and means for introducing oxygen, wherein used waste alkali is oxidized, and an outlet for removing oxidized waste alkali, said outlet for removing oxidized waste alkali being in fluid communication with said indirect heat exchanger, and wherein said oxidation reactor is adapted to operate at a pressure of 60 bar-200 bar.
